(19) United States
(12) Patent Application Publication
(10) Pub. No.: US 2014/0110333 A1
(43) Pub. Date: Apr. 24, 2014

(54) SOLID FROM LIQUID SEPARATION APPARATUS

(71) Applicants: Richard Kibbee, Russell (CA); Craig Pitt, Nepean (CA); Susan Springthorpe, Richmond (CA)

(72) Inventors: Richard Kibbee, Russell (CA); Craig Pitt, Nepean (CA); Susan Springthorpe, Richmond (CA)

(21) Appl. No.: 13/261,758

(22) PCT Filed: Apr. 11, 2012
(86) PCT No.: PCT/CA2012/000346

§ 371 Date: Dec. 16, 2013

Related U.S. Application Data
(60) Provisional application No. 61/457,504, filed on Apr. 12, 2011.

(51) Int. Cl. B01D 21/24

(52) U.S. Cl. CPC B01D 21/2416
USPC 210/519

(57) ABSTRACT

Solids are separated from a liquid in a separator including a cylindrical vessel, a tube extending downwardly from the top of the vessel with a plurality of horizontal rows of alternating large and small holes extending around the tube. Liquid containing solid particles is introduced into the top of the tube and discharged radially through the holes creating a laminar flow. The liquid strikes the side of the vessel where heavier solids are separated and fall to the bottom of the vessel. Light solids and the liquid are discharged through a filter and an outlet at the top of the vessel.

### FIELD OF THE INVENTION

This invention relates to an apparatus for separating particulate solids from liquids and in particular to an apparatus for separating sand particles from water.

### BACKGROUND OF THE INVENTION

Hydraulic fracturing or fracking of subterraneous oil or gas reservoirs is commonly carried out using water containing sand and other particulates for preventing closure of fractures when injection is stopped. Thus, the water pumped from producing wells contains such particulate material, which must be removed if the water is to be re-used. Usually, the water is transported by trucks from the well site, the particulate material is separated from the water, and the water is returned to the well site, again by truck. This practice is decidedly uneconomical and adds to the carbon footprint of the fracking process.

### SUMMARY OF THE INVENTION

The present invention provides a solution to the problem outlined above in the form of a relatively simple apparatus for separating the particulate material from the fracturing fluid at the well site. Of course, the apparatus can be used for separating other solid, particulate material from a liquid.

In more specific terms, the invention provides an apparatus for separating particulate solids from a liquid comprising a vessel having a cylindrical side wall, a top wall and a bottom wall; an inlet tube extending downwardly from said top into the vessel for introducing a solids-containing liquid into the vessel, said inlet tube having a closed bottom end and a plurality of rows of alternating large and small openings for discharging the liquid radially into the vessel, the openings producing a laminar flow in the liquid, which impinges upon the side wall of the vessel, whereby heavy solids are separated from the liquid and descend in the vessel; and a liquid outlet in the top wall of the vessel for discharging liquid from the vessel.

### BRIEF DESCRIPTION OF THE DRAWINGS

The invention is described below in greater detail with reference to the accompanying drawings, which illustrate a preferred embodiment of the invention and wherein:

FIG. 1 is a side view of an apparatus for separating a solid from a liquid in accordance with the invention;

FIG. 2 is a partly sectioned, exploded, side view of the apparatus of FIG. 1;

FIG. 3 is an isometric view of a cover used in the apparatus of FIGS. 1 and 2 as seen from below and one side;

FIG. 4 is a side view of a tube used in the apparatus of FIGS. 1 and 2;

FIG. 5 is a schematic, isometric view of a second embodiment of the apparatus of the present invention;

FIG. 6 is a schematic, partly sectioned, isometric view of the apparatus of FIG. 5;

FIG. 7 is a longitudinal sectional view of the apparatus of FIGS. 5 and 6; and

FIG. 8 is a longitudinal sectional view of a gate valve at the bottom of the apparatus of FIGS. 5 to 7.

### DETAILED DESCRIPTION OF THE INVENTION

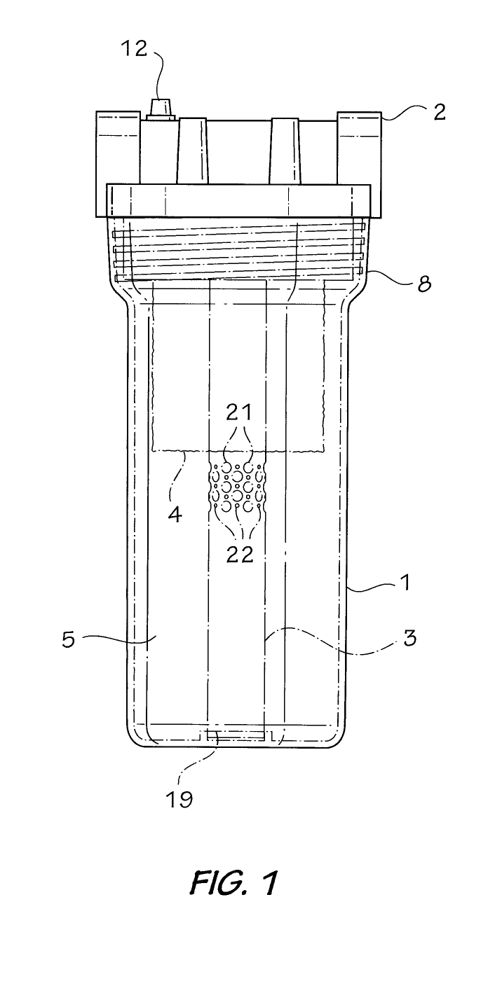

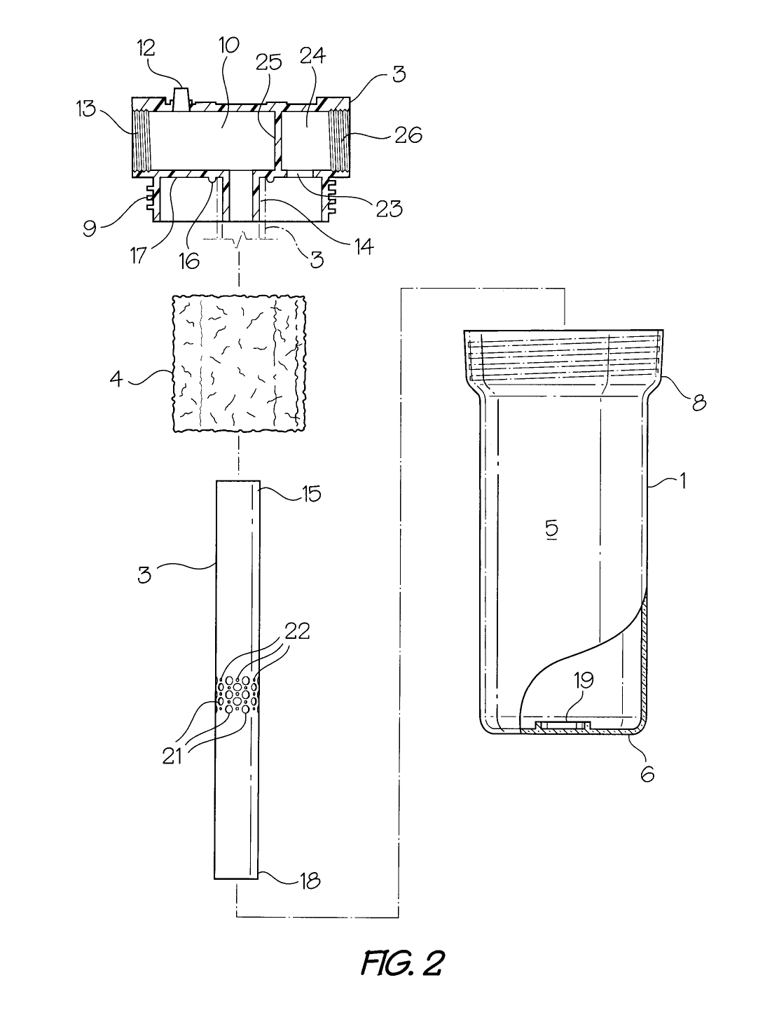

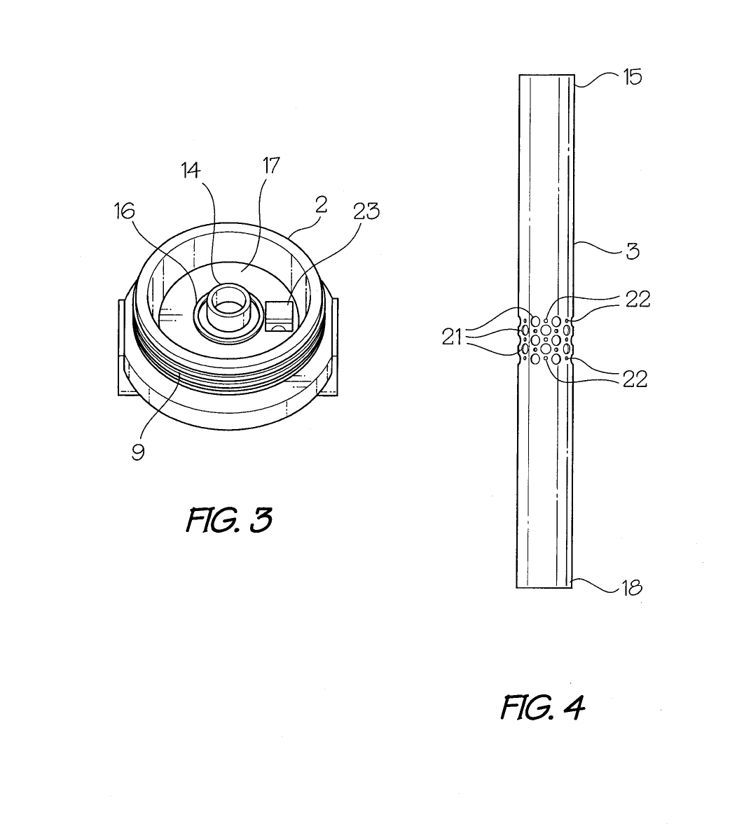

With reference to FIGS. 1 and 2, the basic elements of the apparatus of the present invention are a cylindrical vessel 1, a cover 2 in the vessel 1, an inlet tube 3 and a filter 4. The vessel 1 has a thick side wall 5, a closed bottom end 6 and a wider diameter, internally threaded top end 8 for receiving the externally threaded neck 9 of the cover 2.

Solids-carrying liquid is introduced into the vessel 1 via a cylindrical inlet passage 10 (FIG. 2) in the cover 2 containing a pressure release valve 12. The outer end 13 of the passage 10 is threaded for connecting a pipe (not shown) to the cover 2. The pipe carries liquid under pressure to the vessel 1. Liquid flows through the passage 10 and a short vertical pipe 14 into the tube 3. The top end 15 of the tube 3 is sealed on the pipe 14. An annular, downwardly extending flange 16 on the bottom wall 17 of the cover 2 is used to center the tube 3 with respect to the cover 2. The bottom end 18 of the tube 3 sits in a shallow, cylindrical well 19 on the center of the bottom wall 6 of the vessel 1.

A plurality of horizontal rows of alternating large and small openings 21 and 22, respectively are provided in the tube 3. The tube 3 is closed immediately below such openings 21 and 22. Liquid containing solid particles (in this case, water containing sand and possibly other particulates) is introduced under pressure into the tube 3 and is discharged radially into the vessel 1 via the large and small openings 21 and 22, respectively. The arrangement of openings illustrated in the drawings results in a laminar flow of liquid exiting the openings and impinging upon the side wall 5 of the vessel. The laminar flow serves to cause larger, heavier particles to move downwardly through the liquid in the container while smaller, lighter particles flow upwardly. The liquid carrying the lighter particles passes upwardly through the cylindrical filter 4 surrounding the top end of the tube 3. A suitable filter 4 is formed of a low density, reticulated, polyester/polyether urethane foam. A valve (not shown) can be provided in the bottom wall 6 of the vessel 1 for discharging separated solids from the vessel. The now solids-free liquid is discharged from the vessel 1 via an opening 23 in the bottom wall 17 and an outlet duct 24 in the cover 2. The inner end of the outlet duct 24 is separated from the inlet duct 10 by a partition 25, and the outer end 26 of the duct 10 is threaded for connecting a pipe (not shown) to the apparatus.

In the following description of the second embodiment of the invention, wherever possible, the same reference numbers have been used to identify the same or similar elements.

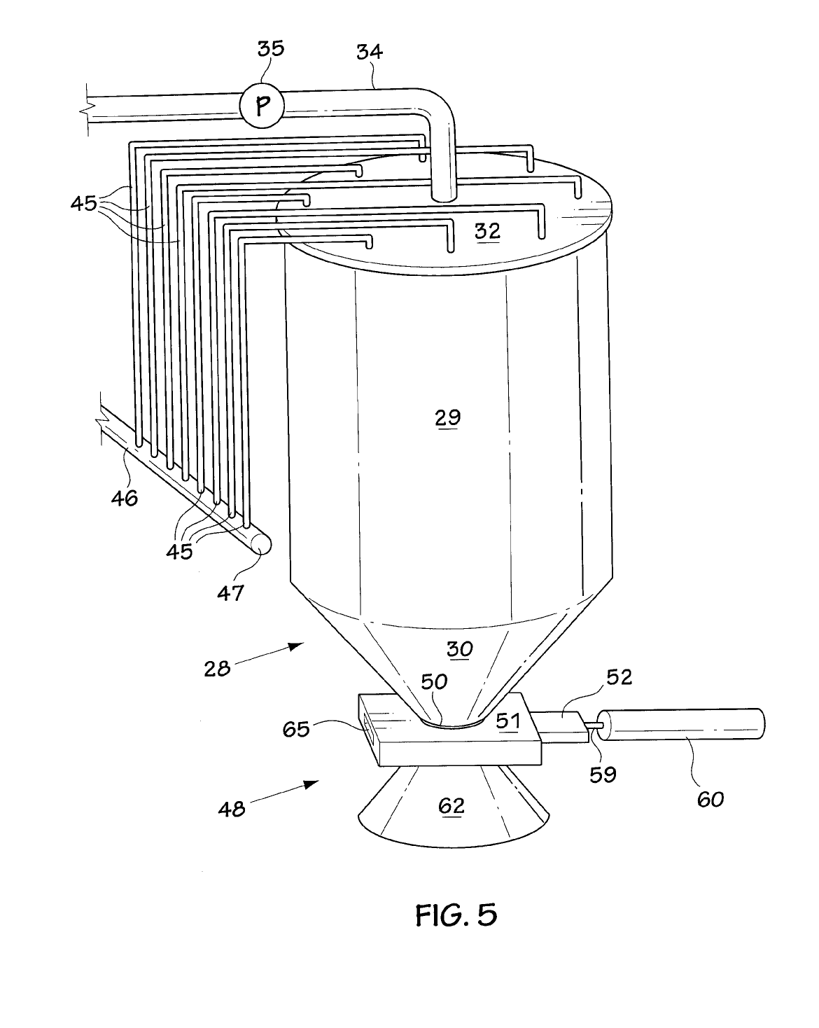

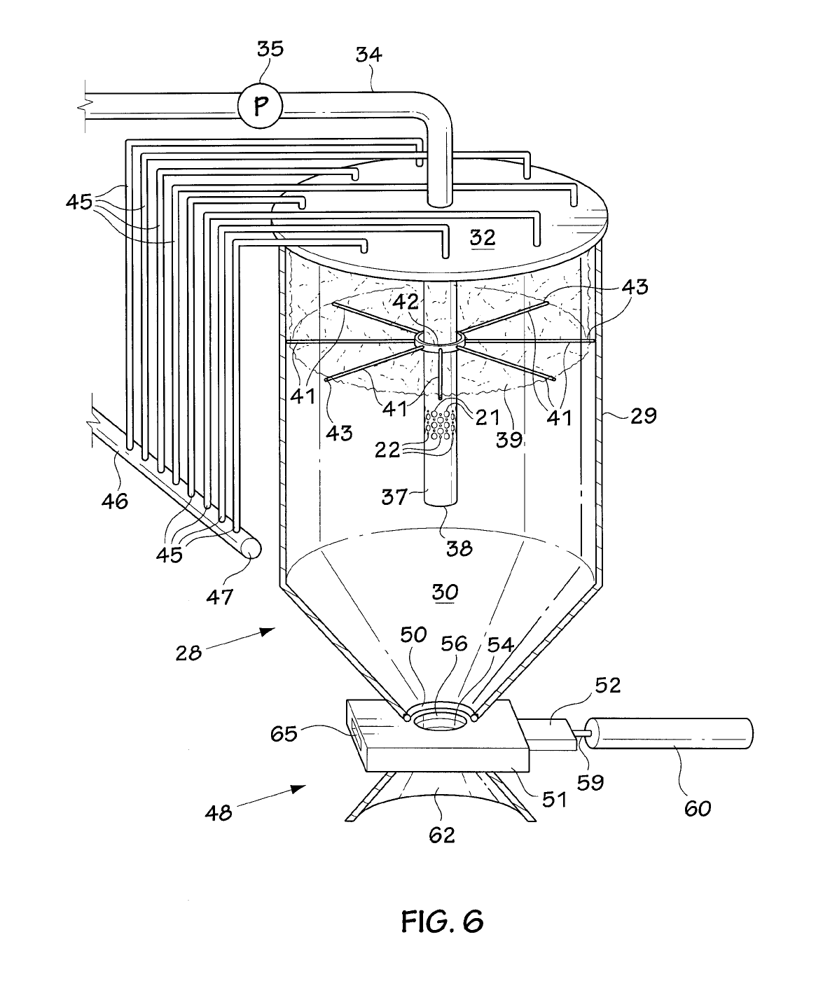

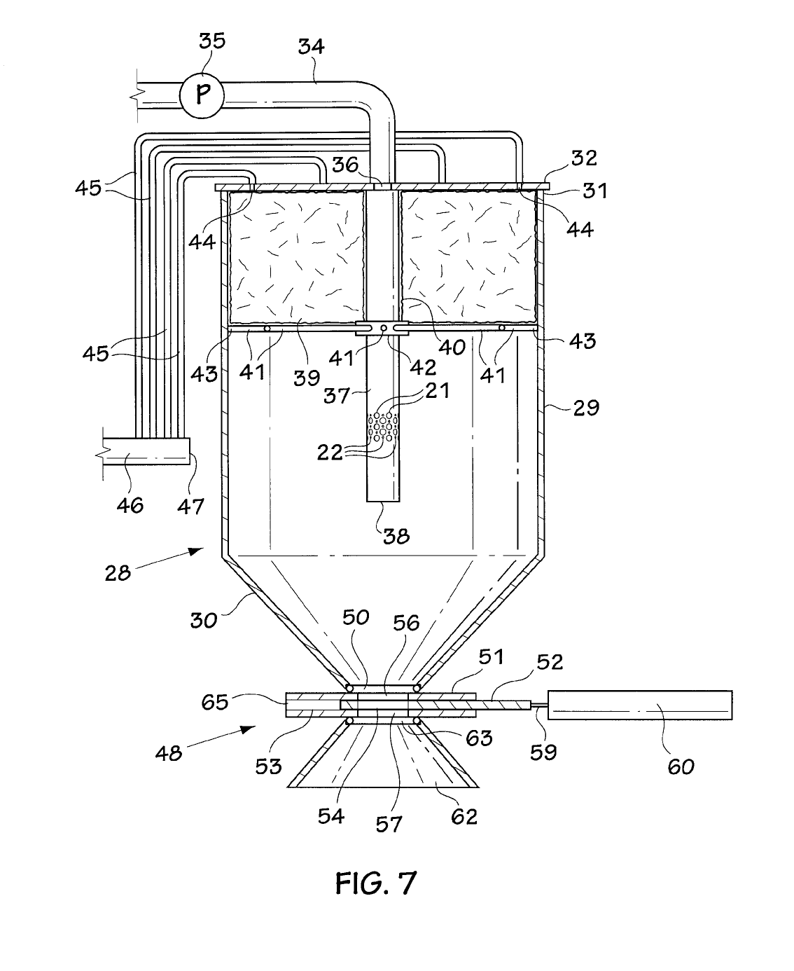

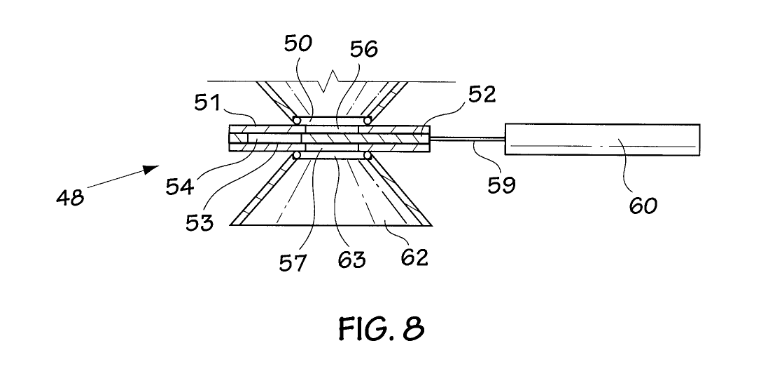

Referring to FIGS. 5 to 7, the second embodiment of the invention includes a vessel indicated generally at 28. The vessel 28 has a cylindrical side wall 29, an inverted cone-shaped bottom end 30 and a top end 31 closed by a cover 32. Solids-containing liquid is introduced into the vessel 28 via a pipe 34 containing a pump 35 and an opening 36 (FIG. 7) in the cover 32. The liquid is received by a tube 37, which has a closed bottom end 38. The tube 37 contains the same arrangement of large and small openings 21 and 22, respectively as the tube 3 in the first embodiment of the invention. Liquid containing solid particles is introduced under pressure into the tube 37 and is discharged radially into the vessel 28 via the openings 21 and 22. As described above, the arrangement of large and small openings results in laminar flow of the liquid, which impinges upon the side wall 29 of the vessel 28.

The laminar flow causes heavier particles to move downwardly through liquid in the container while lighter particles flow upwardly. The liquid carrying the lighter particles flows upwardly through a cylindrical filter 39 containing a central, vertical passage 40 for the tube 37. The filter 39 is supported at the top end of the vessel 28 by a plurality of spokes 41 extending radially outwardly from a ring 42 around and spaced apart from the tube 37. The outer ends 43 of the spokes 41 are welded to the side wall 29 of the vessel 28. The liquid is discharged from the vessel 28 through holes 44 in the cover 32, a plurality of outlet pipes 45 and a manifold 46 connected to the outer ends of the pipes. The manifold 46 has a closed end, and is designed to carry the now solids-free liquid from the apparatus for re-use or disposal.

From time to time a gate valve indicated generally at 48 is opened to discharge solids containing some liquid from the open bottom end 30 of the vessel 28. An annular seal 50 is provided between the grooved discharge end of the vessel 28 and the body 51 of the valve 48. A gate 52 having a rectangular cross-section slides in a similarly shaped, longitudinally extending passage 53 in the valve body 51. The gate 52 has an opening 54 proximate one end thereof which can be aligned with openings 56 and 57 in the top and bottom of the valve body 51. An outer end of the gate 52 is connected to a piston rod 59 extending out of a hydraulic cylinder 60, which moves the gate between open and closed positions.

When the gate 52 is in the open position (FIG. 7), separated solids flow through the aligned openings 54, 56 and 57 and a conical baffle 62 mounted on the bottom of the valve body 51. An annular seal 63 (FIGS. 7 and 8) is sandwiched between the grooved top of the baffle 62 and the bottom of the valve body 51 around the opening 57. When the piston rod 59 is extended, the gate 52 slides to the closed position (FIG. 8) in which the opening 54 in the gate is no longer aligned with the openings 56 and 57 in the valve body 51. As it closes, the gate 52 pushes any solids in the open end 65 of the passage 53 out of the body 51.

It will be appreciated that a plurality of apparatuses of the type described above can be permanently installed at a well site; thus obviating the need for transporting of solids-containing liquid to and from an off-site separator. The solids-free water discharged from the apparatus can immediately be re-used in a fracking or other operation.

1. An apparatus for separating particulate solids from a liquid comprising a vessel having a cylindrical side wall, a top wall and a bottom wall; an inlet tube extending downwardly from said top into the vessel for introducing a solids-containing liquid into the vessel, said inlet tube having a closed bottom end and a plurality of rows of alternating large and small openings for discharging the liquid radially into the vessel, the openings producing a laminar flow in the liquid, which impinges upon the side wall of the vessel, whereby heavy solids are separated from the liquid and descend in the vessel; and a liquid outlet in the top wall of the vessel for discharging liquid from the vessel.

2. The apparatus of claim 1, including a filter in said vessel above said openings for filtering light solids remaining in the liquid before the liquid is discharged through said liquid outlet.

3. The apparatus of claim 2, including a solids outlet in the bottom of the vessel for discharging solids from the bottom of the vessel; and a valve in said solids outlet.

4. The apparatus of claim 3, wherein said valve is a gate valve.

5. The apparatus of claim 4, wherein said valve includes a tubular body, a horizontal passage in said body, vertically aligned openings in top and bottom walls of said body, and a gate slidable in said body for blocking the openings or for permitting the discharge of solids through said openings.

6. The apparatus of claim 5, wherein said gate includes a hole for alignment with the openings in the valve body in the open position of the valve.

7. The apparatus of claim 6, wherein said valve body has a open end through which particulate material can be expelled when the gate is moved from the open to a closed position.

8. The apparatus of claim 3, wherein said liquid outlet includes a plurality of outlet pipes on the top wall of the vessel; and a manifold for receiving liquid from said outlet pipes for carrying liquid from the apparatus for re-use or disposal.
